(19) United States
(12) Patent Application Publication
(10) Pub. No.: US 2023/0245353 A1
(43) Pub. Date: Aug. 3, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Tatsuya MORI, Kanagawa (JP)

(73) Assignee: FUJIFILM Business Innovation Corp., Tokyo (JP)

(21) Appl. No.: 17/895,452

(22) Filed: Aug. 25, 2022

(30) Foreign Application Priority Data
Feb. 3, 2022 (JP) 2022-015334

(51) Int. Cl. G06T 11/00; G06F 3/04845

(52) U.S. Cl. CPC G06T 11/001; G06F 3/04845; G06T 2200/24; G06F 3/0488

(57) ABSTRACT

An information processing apparatus includes a processor configured to: control an operation unit that receives an input operation and that has an operation image in which a texture sensible from an external appearance of the operation image is changed in accordance with the input operation; control a display that displays a target image to be edited; and reflect the texture sensible from the external appearance on the target image in accordance with the input operation performed on the operation image.

### CROSS-REFERENCE TO RELATED APPLICATIONS

This application is based on and claims priority under 35 USC 119 from Japanese Patent Application No. 2022-015334 filed Feb. 3, 2022.

### BACKGROUND

### (i) Technical Field

The present disclosure relates to an information processing apparatus, a non-transitory computer readable medium, and an information processing method.

### (ii) Related Art

The texture of an image is typically controlled by using image editing software. To express an intended texture, a user who edits the image is required to be highly skilled to be able to perform complicated input operations.

Thus, technologies to easily control the intended image texture even by a not highly skilled user have been proposed. (for example, Japanese Patent No. 6667739).

### SUMMARY

However, an easier method to control an image texture in line with user's intentions than existing methods is to be developed.

Aspects of non-limiting embodiments of the present disclosure relate to enabling even a not highly skilled user to control an image texture by an easier method than existing methods.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, an information processing apparatus is provided including a processor configured to: control an operation unit that receives an input operation and that has an operation image in which a texture sensible from an external appearance of the operation image is changed in accordance with the input operation; control a display that displays a target image to be edited; and reflect the texture sensible from the external appearance on the target image in accordance with the input operation performed on the operation image.

### BRIEF DESCRIPTION OF THE DRAWINGS

An exemplary embodiment of the present disclosure will be described in detail based on the following figures, wherein:

FIG. 1 is a diagram illustrating an example of the overall configuration of an information processing system to which this exemplary embodiment is applied;

FIG. 2 is a diagram illustrating the hardware configuration of a user terminal serving as an information processing apparatus to which this exemplary embodiment is applied;

FIG. 3 is a diagram illustrating the functional configuration of a controller of the user terminal in a case where the user terminal controls a texture sensible from the external appearance of an operation image and reflects the texture on a target image;

FIG. 4 is a diagram illustrating the functional configuration of the controller of the user terminal in a case where a management server controls the texture sensible from the external appearance of the operation image and reflects the texture on the target image;

FIG. 5 is a diagram illustrating the functional configuration of a controller of the management server in the case where the management server controls the texture sensible from the external appearance of the operation image and reflects the texture on the target image;

FIG. 6 is a flowchart illustrating the processing performed by the user terminal in the case where the user terminal controls the texture sensible from the external appearance of the operation image and reflects the texture on the target image;

FIG. 7 is a flowchart illustrating the processing performed by the user terminal in the case where the management server controls the texture sensible from the external appearance of the operation image and reflects the texture on the target image;

FIG. 8 is a flowchart illustrating the processing performed by the management server in the case where the management server controls the texture sensible from the external appearance of the operation image and reflects the texture on the target image;

FIGS. 9A and 9B are both views illustrating specific examples of operations performed on the operation image displayed on a user interface;

FIGS. 10A and 10B are both views illustrating specific examples of operations performed on the operation image displayed on the user interface;

FIG. 11 is a view illustrating a specific example of an operation for selecting a combination of operation-image parameters displayed on the user interface;

FIG. 12 is a view illustrating a specific example of an operation for selecting imagery images having respective visualized textures defined by combinations of operation-image parameters displayed on the user interface; and

FIGS. 13A to 13D are views each illustrating a specific example of a texture change on the operation image represented as a sphere in response to an operation on an operation image and a texture change of the target image to match the same texture as the operation image.

### DETAILED DESCRIPTION

Hereinafter, an exemplary embodiment of the present disclosure will be described in detail with reference to the attached drawings.

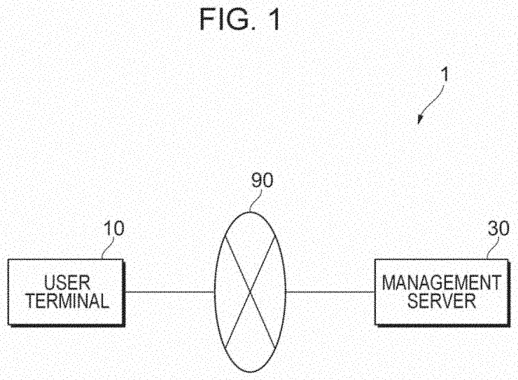

Configuration of Information Processing System FIG. 1 is a diagram illustrating an example of the overall configuration of an information processing system 1 to which this exemplary embodiment is applied.

The information processing system 1 includes a user terminal 10 and a management server 30 that are connected via a network 90. The network 90 is, for example, a local area network (LAN) or the Internet.

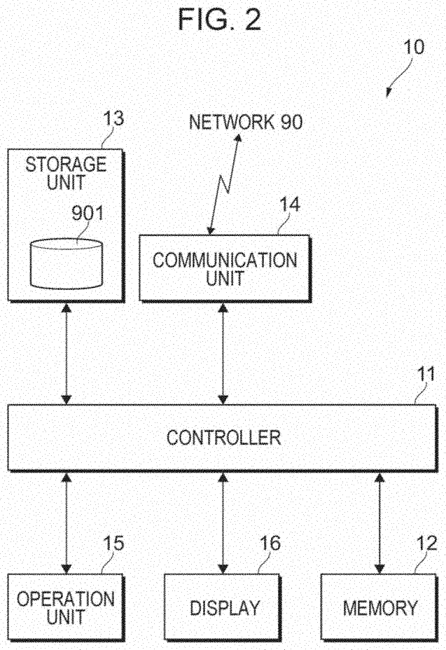

The user terminal 10 is an information processing apparatus operated by a user, such as a personal computer, a smartphone, or a tablet terminal. For example, the user terminal 10 controls an operation unit 15 (see FIG. 2) that receives an input operation and has an image in which a texture sensible from the external appearance of the image is changed in accordance with the input operation (hereinafter, referred to as an operation image). The term “texture” denotes an impression and imagery caused by a look at an image. For example, the user terminal 10 also controls a display 16 (see FIG. 2) that displays an image to be edited (hereinafter, referred to as a target image). For example, the user terminal 10 also reflects, on the target image, the texture sensible from the external appearance of the operation image, in accordance with the input operation performed on the operation image.

The management server 30 is an information processing apparatus serving as a server that performs the overall management of the information processing system 1. The management server 30 may perform part of the above-described processing by the user terminal 10. In other words, the management server 30 may perform at least partial processing of the control of the texture sensible from the external appearance of the operation image and the reflection of the texture on the target image. In this case, the user terminal 10, for example, acquires various pieces of information transmitted from the management server 30, displays pieces of information on the user interface, and transmits information input to the user interface to the management server 30. The details of the processing will be described later.

The above-described configuration of the information processing system 1 is an example, and any configuration for functions implementing the processing by the information processing system 1 as a whole may be employed. Accordingly, the user terminal 10 and the management server 30 in the information processing system 1 may take charge of part or the entirety of the functions for implementing the processing or may implement the processing in cooperation with each other. In other words, the management server 30 may implement part or the entirety of the function of the user terminal 10, or the user terminal 10 may implement part or the entirety of the function of the management server 30. Further, part or the entirety of the functions of the user terminal 10 and the management server 30 included in the information processing system 1 may be transferred to another server or the like (not illustrated). The processing by the information processing system 1 as a whole may thereby be promoted and supplemented mutually.

### Hardware Configuration of User Terminal

FIG. 2 is a diagram illustrating the hardware configuration of the user terminal 10 serving as the information processing apparatus to which this exemplary embodiment is applied.

The user terminal 10 includes a controller 11, a memory 12, a storage unit 13, a communication unit 14, the operation unit 15, and the display 16. These components are connected via a data bus, an address bus, a peripheral component interconnect (PCI) bus, or the like.

The controller 11 is a processor configured to control the function of the user terminal 10 by running various pieces of software such as the OS (basic software) and application software. The controller 11 is configured from, for example, a central processing unit (CPU). The memory 12 is a memory area where various pieces of software and data used to run the software are stored. The memory 12 is used as a working area in arithmetic operations. The memory 12 is configured from, for example, a random access memory (RAM).

The storage unit 13 is a memory area where data input and output to and from various pieces of software are stored. The storage unit 13 is configured from a hard disk drive (HDD), a solid state drive (SSD), a semiconductor memory, or the like used to store, for example, programs and various pieces of setting data. The storage unit 13 stores a parameter DB 901 and the like. The parameter DB 901 serves as a database that stores various pieces of information and thus stores, for example, operation-image parameters and target-image parameters.

The communication unit 14 transmits and receives data to and from the management server 30 and an external apparatus via the network 90. The operation unit 15 is composed of, for example, a keyboard, a mouse, mechanical buttons, and switches and receives an input operation. The operation unit 15 has an operation image displayed on the display 16. The operation unit 15 includes a touch sensor forming a touch panel integrally with the display 16. The display 16 is composed of, for example, a liquid crystal display or an organic electro luminescence (EL) display that are used to display information. The display 16 displays an image, text data, and the like. The user interface is displayed on the display 16.

### Hardware Configuration of Management Server

The hardware configuration of the management server 30 is the same as the hardware configuration of the user terminal 10 illustrated in FIG. 2, and thus the illustration and description thereof are omitted.

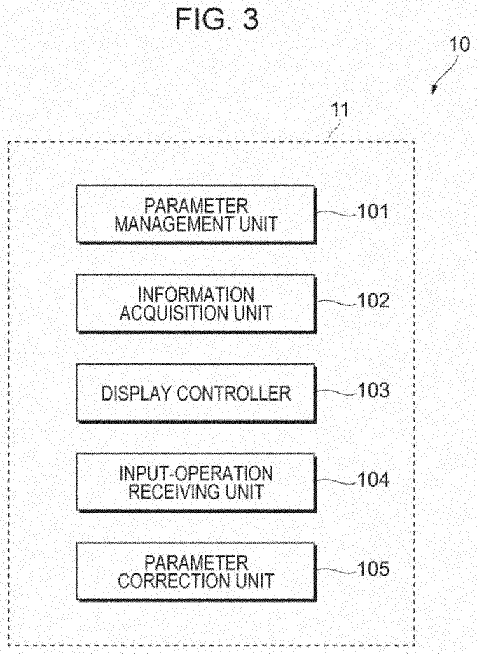

Functional Configuration of Controller of User Terminal FIG. 3 is a diagram illustrating the functional configuration of the controller 11 of the user terminal 10 in a case where the user terminal 10 controls the texture sensible from the external appearance of an operation image and reflects the texture on a target image.

In a case where the user terminal 10 performs control of an operation unit having an operation image, control of a display displaying a target image, and reflection of the texture sensible from the external appearance of the operation image on the target image, a parameter management unit 101, an information acquisition unit 102, a display controller 103, an input-operation receiving unit 104, and a parameter correction unit 105 function in the controller 11 of the user terminal 10.

The parameter management unit 101 stores parameter information that defines a texture sensible from the external appearance of the operation image (hereinafter, referred to as an operation-image parameter) and parameter information that defines a texture sensible from the external appearance of target image (hereinafter, referred to as a target-image parameter) in a database and manages the parameters. Specifically, the parameter management unit 101 stores the operation-image parameter and the target-image parameter in the parameter DB 901 of the storage unit 13 (see FIG. 2) serving as a memory and manages the parameters.

The information acquisition unit 102 acquires various pieces of information. For example, the information acquisition unit 102 acquires the operation-image parameter and the target-image parameter managed by the parameter management unit 101. The operation-image parameter and the target-image parameter may be defined by, for example, information indicating the illumination component of an image and information indicating the color components of the image. The information indicating the illumination component of the image may be expressed by a grayscale representing lightness, and the information indicating the color components of the image may be expressed, for example, by using a color space based on an RGB value representing color components of red (R), green (G), and blue (B) per pixel of an image, a color space based on a HSV value representing color components of hue (H), saturation (S), and brightness (V), or a color space based on a LAB value representing color components of brightness (L), hue and saturation (A), and hue and saturation (B).

The information indicating the illumination component of the image also includes information indicating how light hits the image, and the information indicating how light hits the image includes, for example, information indicating the direction of the light and information indicating the intensity of the light. As the information indicating the direction of the light, values defined in the three-dimensional coordinates (an X-axis, a Y-axis, and a Z-axis) representing a position where the light is projected is cited as an example. As the information indicating the intensity of the light, for example, a value representing light intensity using levels (for example, representing using five levels) is cited. Note that how to define the operation-image parameter and the target-image parameter is not limited to the above-described method in which the parameters are defined by the information indicating the color components and the information indicating the illumination component.

The display controller 103 performs control to cause the display 16 (see FIG. 2) serving as a display to display various pieces of information. For example, the display controller 103 performs control to cause the display 16 to display the user interface. The user interface may be displayed by starting application software dedicated to the user installed in advance on the user terminal 10 or by accessing a web site dedicated to the user.

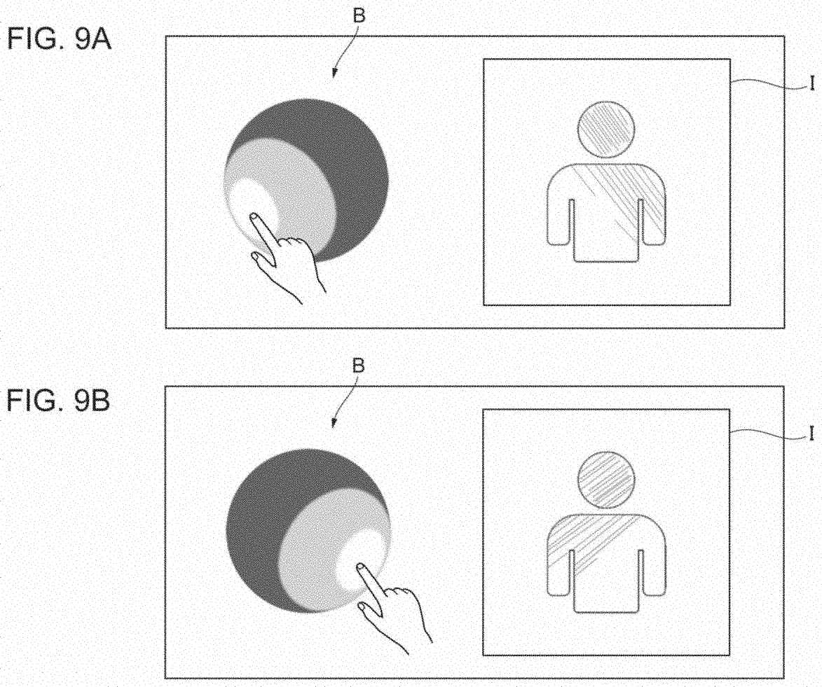

The display controller 103 performs control to display, on the user interface, the operation image in a state where the texture of an image is sensible by the user who performs an input operation. In the state where the texture is sensible, for example, an appearance is imagerially represented as a sphere. Specifically, the display controller 103 performs control to display, on the user interface, a spherical operation image on which the operation-image parameter acquired by the information acquisition unit 102 is reflected. Note that the operation image is not limited to the sphere, and any form may be used. Specific examples of the operation image displayed on the user interface will be described later with reference to FIGS. 9A to 13D.

For example, the display controller 103 also performs control to display, on the user interface, the target image having the operation image texture reflected thereon. Specifically, the display controller 103 performs control to display, on the user interface, the target image on which the target-image parameter acquired by the information acquisition unit 102 is reflected. Specific examples of the target image displayed on the user interface will be described later with reference to FIGS. 9A to 13D.

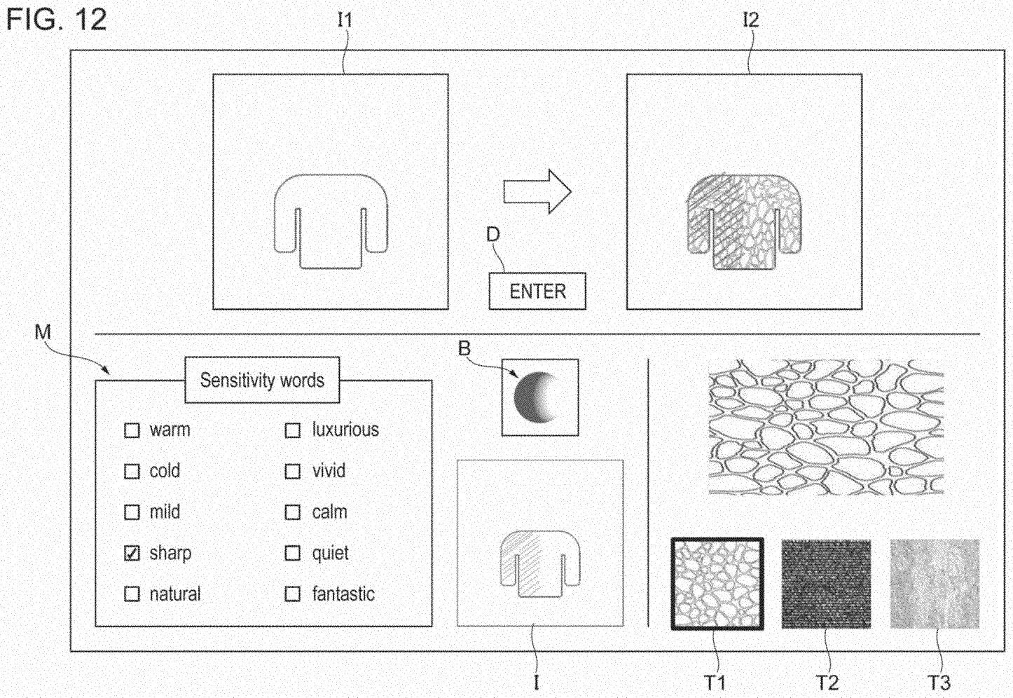

For example, the display controller 103 also performs control to display a combination of the operation-image parameters on the user interface. Specifically, for example, the display controller 103 performs control to display, on the user interface, options as sensitivity words representing textures for combinations of the operation-image parameters. The term “sensitivity word” denotes an adjective representing a psychological feeling of the user in response to a stimulus from the outside. Examples thereof include words “warm”, “cold”, “luxurious”, and “vivid”. A specific example of the options as the sensitivity words displayed on the user interface will be described later with reference to FIG. 12.

For example, the display controller 103 also performs control to further display, on the user interface, options as imagery images having respective visualized textures defined by the combinations of the operation-image parameters. Examples of the imagery image having a visualized texture include an image typically used to express a texture. A specific example of the options as the imagery images having respective visualized textures displayed on the user interface will be described later with reference to FIG. 12.

For example, the display controller 103 also performs control to display, on the user interface, the operation image and the target image that have a changed texture. In response to receiving an input operation for selecting one of combinations of the operation-image parameters displayed on the user interface in a form of the sensitivity words or imagery images, the texture is changed in accordance with the selected combination.

The input-operation receiving unit 104 serves as an operation controller and a receiving unit and receives an input operation by the user. For example, the input-operation receiving unit 104 receives an input operation performed on the operation image displayed on the user interface. For example, the input-operation receiving unit 104 also receives an input operation for selecting a combination of the operation-image parameters (for example, the sensitivity words or the texture images) displayed in a selectable manner on the user interface. The input-operation receiving unit 104 receives an input operation performed on the operation image regardless of whether the operation for selecting a combination of the operation-image parameters is received. The user performs an input operation on the operation image after selecting a sensitivity word and may thereby perform fine tuning of the texture sensible from the operation image and the target image.

Examples of the input operation performed on the operation image include an operation for correcting information indicating how light hits the operation image. The operation is performed by a touch or an operation using the mouse (mouse operation) on the operation image displayed on the user interface. Examples of the operation for correcting information indicating how light hits the operation image include an operation for correcting information indicating the direction of light, an operation for correcting information indicating the intensity of light, and the like.

Examples of the operation for correcting information indicating the direction of light include an operation for designating the direction of light hitting the operation image. The operation is performed by a tap or a click on the operation image. Examples of the operation for correcting information indicating the intensity of light include operation for designating the intensity of light hitting the operation image. The operation is performed by a pinch gesture or a scroll-wheel operation on the operation image.

The pinch gesture on the operation image includes a pinch-out. For example, a pinch-out enables the strengthening of the light hitting the operation image to be designated. The pinch-out denotes an operation for increasing a distance between two fingers on the touch panel. The pinch gesture on the operation image also includes a pinch-in, and a pinch-in enables the weakening of the light hitting the operation image to be designated. The pinch-in denotes an operation for decreasing the distance between two fingers on the touch panel.

The touch and the mouse operation described above are an example of an input operation performed on the operation image and another method may also be used. For example, the operation for designating the intensity of light hitting the operation image is not limited to the pinch-out and the pinch-in described above, and the light intensity may be designated on the basis of the duration of a so-called long-press in the touch and the mouse operation. In this case, for example, the initial value is set corresponding to a state where light does not hit. If a double-tap or a double-click is performed after a long-press, the designation of the light intensity may be cancelled to return to the initial value.

The parameter correction unit 105 serves as a reflection unit. The parameter correction unit 105 corrects the operation-image parameter in accordance with an input operation performed on the operation image and reflects the correction on the target-image parameter. Specifically, the parameter correction unit 105 corrects the operation-image parameter on the basis of the combination of parameters identified by input information received by the input-operation receiving unit 104 and reflects the correction on the target-image parameter. The term “reflecting” denotes correcting the target-image parameter performed in accordance with the correction of the operation-image parameter to have the same texture in the target image and the operation image.

If the texture is defined by the information indicating an illumination component and the information indicating color components that serve as the target-image parameters, the parameter correction unit 105 corrects the target-image parameter, for example, by using the following method. The parameter correction unit 105 first resolves a target image (I) into a shading component (S) representing the illumination component and a reflectance component (R) representing the color components and then resolves the shading component (S) into a normal map (N) representing the shape of an object and a light parameter (L) representing how light hits.

Specifically, the parameter correction unit 105 corrects the target-image parameter by performing calculation using an expression such as I=S×R or S=f(N,L). The parameter correction unit 105 may thereby calculate the normal map (N), the light parameter (L), and the reflectance component (R) from the target image (I) and also calculate backwards.

The method for calculating the normal map (N), the light parameter (L), and the reflectance component (R) is not particularly limited. For example, a method by which an assumed value set in advance of the target-image parameter is optimized, a method using estimation results of machine learning such as deep learning, and other methods may be used. In addition, the set value of the light parameter (L) may be changed, and the shading component (S) may be calculated by using f using spherical harmonics or an inner product.

For example, in response to a pinch-out on the operation image, the parameter correction unit 105 corrects the information indicating the intensity of the light to strengthen the light hitting the operation image and reflects the correction on the target image. In response to a pinch-in included in the pinch gesture on the operation image, the parameter correction unit 105 corrects the information indicating the intensity of the light to weaken the light hitting the operation image and reflects the correction on the target image.

As the result of the processing for correcting the operation-image parameter and the target-image parameter performed by the parameter correction unit 105, the texture sensible from the corrected operation image and the texture sensible from the corrected target image become identical. The user may thereby freely set the texture of the target image while looking at the texture of the operation image varying in accordance with an operation on the operation image.

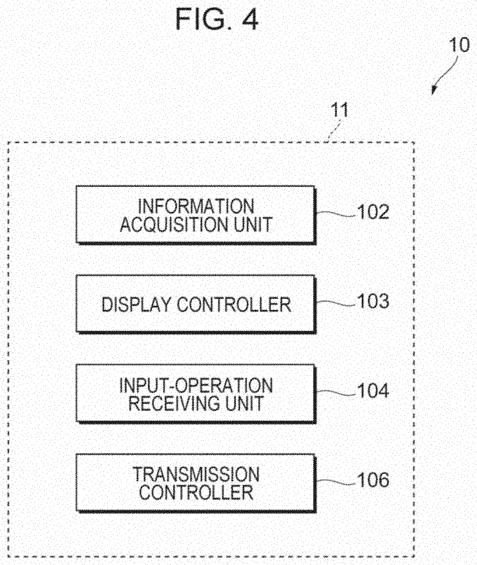

FIG. 4 is a diagram illustrating the functional configuration of the controller 11 of the user terminal 10 in a case where the management server 30 controls the texture sensible from the external appearance of the operation image and reflects the texture on the target image.

In the case where the management server 30 reflects the texture sensible from the external appearance of the operation image on the target image, the information acquisition unit 102, the display controller 103, the input-operation receiving unit 104, and a transmission controller 106 function in the controller 11 of the user terminal 10. The functions of the display controller 103 and the input-operation receiving unit 104 are the same as the functions in FIG. 3 described above, and thus description thereof is omitted.

The information acquisition unit 102 acquires various pieces of information. For example, the information acquisition unit 102 acquires the operation-image parameter and the target-image parameter transmitted from the management server 30. The operation-image parameter and the target-image parameter acquired by the information acquisition unit 102 include an operation-image parameter and a target-image parameter corrected by the management server 30.

The transmission controller 106 performs control to transmit various pieces of information to the management server 30 or the outside via the communication unit 14 (see FIG. 2). For example, the transmission controller 106 performs control to transmit data regarding the target image to the management server 30. For another example, the transmission controller 106 also performs control to transmit, to the management server 30, input information for which an input operation is received by the input-operation receiving unit 104.

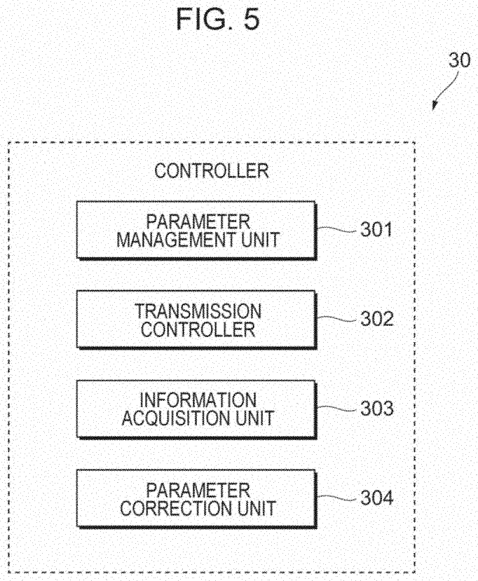

Functional Configuration of Controller of Management Server FIG. 5 is a diagram illustrating the functional configuration of the controller of the management server 30 in the case where the management server 30 controls the texture sensible from the external appearance of the operation image and reflects the texture on the target image.

In the case where the management server 30 reflects the texture sensible from the external appearance of the operation image on the target image, a parameter management unit 301, a transmission controller 302, an information acquisition unit 303, and a parameter correction unit 304 function in the controller of the management server 30. The functions of the parameter management unit 301 and the parameter correction unit 304 are the same as the functions of the parameter management unit 101 and the parameter correction unit 105 in FIG. 3, and thus description thereof is omitted.

The transmission controller 302 performs control to transmit various pieces of information to the user terminal 10 or the outside via a communication unit. For example, the transmission controller 302 performs control to transmit data regarding the operation image and data regarding the target image to the user terminal 10. The data regarding the operation image and the data regarding the target image transmitted to the user terminal 10 include the operation-image parameter and the target-image parameter corrected by the management server 30.

The information acquisition unit 303 acquires various pieces of information via the communication unit. For example, the information acquisition unit 303 acquires the data regarding the target image transmitted from the user terminal 10 and input information an input operation for which is received.

### Processing by User Terminal

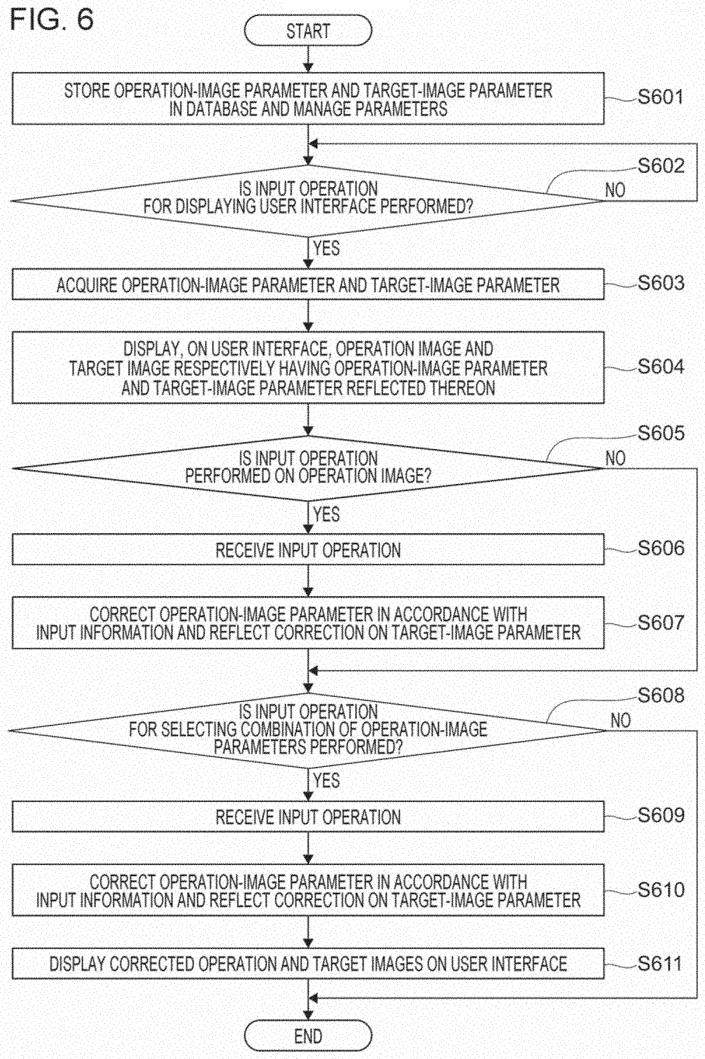

FIG. 6 is a flowchart illustrating the processing performed by the user terminal 10 in the case where the user terminal 10 controls the texture sensible from the external appearance of the operation image and reflects the texture on the target image.

The user terminal 10 stores an operation-image parameter and a target-image parameter in the database and manages the parameters (step S601). Specifically, the user terminal 10 stores the operation-image parameter and the target-image parameter in the parameter DB 901 of the storage unit 13 (see FIG. 2) and manages the parameters.

After the input operation for the user to display the user interface is performed (YES in step S602), the user terminal 10 acquires the operation-image parameter and the target-image parameter stored and managed in the database (step S603) and displays, on the user interface, the operation image and the target image respectively having the acquired operation-image parameter and the acquired target-image parameter reflected thereon (step S604). In contrast, if an input operation for displaying the user interface is not performed (NO in step S602), step S602 is repeated.

If an input operation on the operation image displayed on the user interface is performed (YES in step S605), the user terminal 10 receives the input operation (step S606), corrects the operation-image parameter in accordance with input information, and reflects the correction on the target-image parameter (step S607). In contrast, if an input operation on the operation image is not performed (NO in step S605), the processing proceeds to step S608.

If an input operation for selecting a combination of the operation-image parameters displayed in the selectable manner on the user interface is performed (YES in step S608), the user terminal 10 receives the input operation (step S609). The user terminal 10 then corrects the operation-image parameter in accordance with input information, reflects the correction on the target-image parameter (step S610), and displays the corrected operation image and the corrected target image on the user interface (step S611). In contrast, if an input operation for selecting a combination of the operation-image parameters is not performed (NO in step S608), the processing is terminated.

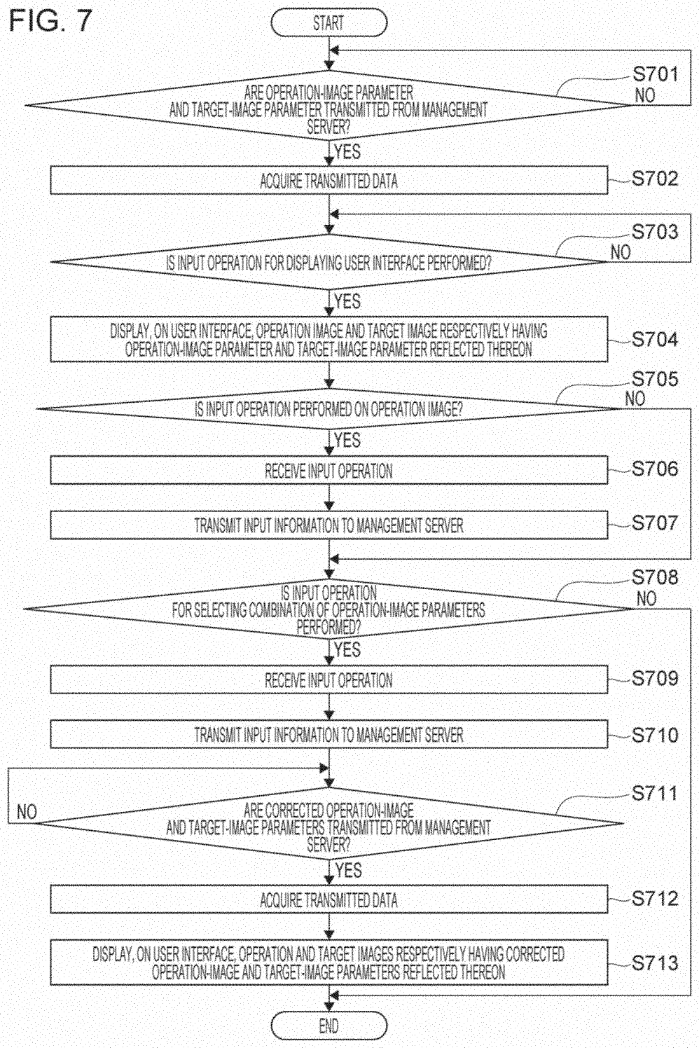

FIG. 7 is a flowchart illustrating the processing performed by the user terminal 10 in the case where the management server 30 controls the texture sensible from the external appearance of the operation image and reflects the texture on the target image.

If an operation-image parameter and a target-image parameter are transmitted from the management server 30 (YES in step S701), the user terminal 10 acquires the transmitted data (step S702). In contrast, if an operation-image parameter and a target-image parameter are not transmitted (NO in step S701), the user terminal 10 repeats step S701.

If an input operation for displaying the user interface is then performed (YES in step S703), the user terminal 10 displays, on the user interface, the operation image and the target image respectively having the operation-image parameter and the target-image parameter acquired in step S702 that are reflected thereon (step S704). In contrast, if an input operation for displaying the user interface is not performed (NO in step S703), the user terminal 10 repeats step S703.

If an input operation on the operation image displayed on the user interface is performed (YES in step S705), the user terminal 10 receives the input operation (step S706) and transmits input information to the management server 30 (step S707). In contrast, if an input operation on the operation image is not performed (NO in step S705), the user terminal 10 proceeds to step S708.

If an input operation for selecting a combination of the operation-image parameters displayed in the selectable manner on the user interface is performed (YES in step S708), the user terminal 10 receives the input operation (step S709) and transmits input information to the management server 30 (step S710). In contrast, if an input operation for selecting a combination of the operation-image parameters is not performed (NO in step S708), the processing by the user terminal 10 is terminated.

If the corrected operation-image parameter and the corrected target-image parameter are transmitted from the management server 30 (YES in step S711), the user terminal 10 acquires the transmitted data (step S712) and displays, on the user interface, the operation image and the target image respectively having the corrected operation-image parameter and the corrected target-image parameter that are reflected thereon (step S713). In contrast, if the corrected operation-image parameter and the corrected target-image parameter are not transmitted (NO in step S711), the user terminal 10 repeats step S711.

### Processing by Management Server

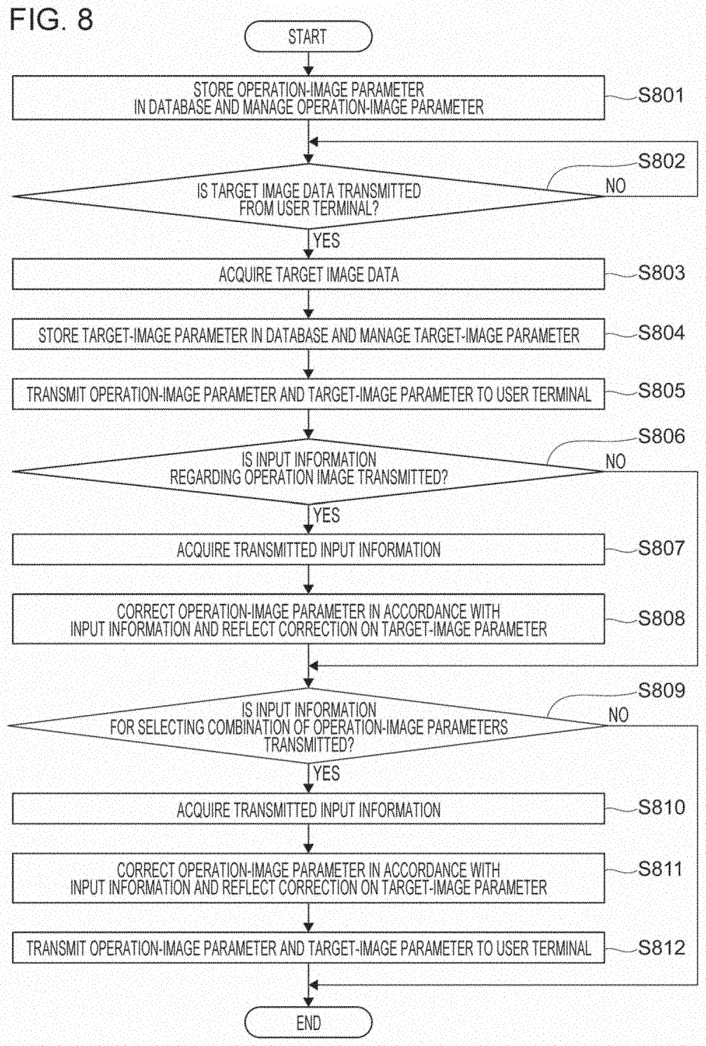

FIG. 8 is a flowchart illustrating the processing performed by the management server 30 in the case where the management server 30 controls the texture sensible from the external appearance of the operation image and reflects the texture on the target image.

The management server 30 stores an operation-image parameter in the database and manages the operation-image parameter (step S801). If data regarding a target image is transmitted from the user terminal 10 (YES in step S802), the management server 30 acquires the transmitted data regarding the target image (step S803), stores the target-image parameter of the acquired target image in the database, and manages the target-image parameter (step S804). In contrast, if data regarding a target image is not transmitted from the user terminal 10 (NO in step S802), the management server 30 repeats step S802.

In response to an inquiry from the user terminal 10, the management server 30 transmits the operation-image parameter and the target-image parameter stored and managed in the database to the user terminal 10 (step S805). If the input information regarding the operation image is transmitted from the user terminal 10 (YES in step S806), the management server 30 acquires the transmitted input information (step 3807), corrects the operation-image parameter in accordance with the input information, and reflects the correction on the target-image parameter (step S808). In contrast, if the content of an input operation on the operation image is not transmitted (NO in step S806), the processing proceeds to step S809.

If the input information for selecting a combination of the operation-image parameters is transmitted from the user terminal 10 (YES in step S809), the management server 30 acquires the transmitted input information (step S810), corrects the operation-image parameter in accordance with the input information, and reflects the correction on the target-image parameter (step S811). The management server 30 then transmits the corrected operation-image parameter and the corrected target-image parameter to the user terminal 10 (step S812). In contrast, if the input information for selecting a combination of the operation-image parameters is not transmitted (NO in step S809), the processing by the user terminal 10 is terminated.

### SPECIFIC EXAMPLES

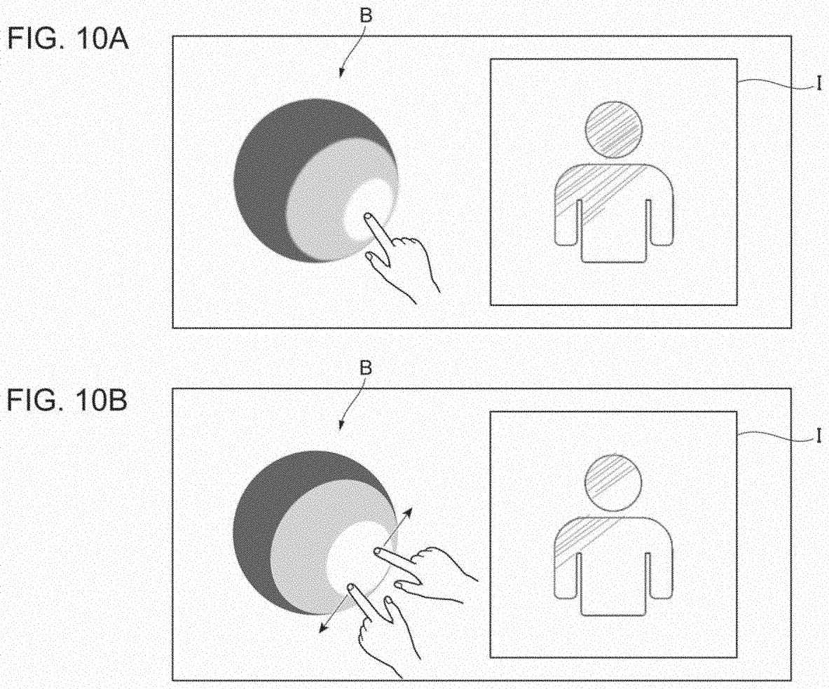

FIGS. 9A to 10B are views each illustrating a specific example of an operation performed on the operation image displayed on the user interface. FIGS. 9A to 10B each illustrate respective specific examples of the operation image and a target image displayed on the user interface.

FIGS. 9A and 9B illustrate specific examples of operations for correcting the information indicating the direction of the light. The operation is included in the operation for correcting the information indicating how the light hits included in the operation-image parameter. For example, as illustrated in FIG. 9A, in response to a touch on the lower left portion of an operation image B representing a sphere, the operation-image parameter is corrected, and the operation image B in a state where light is received from the lower left portion is displayed on the user interface. The target-image parameter is then also corrected, and a target image I in the state where light is received from the lower left portion is displayed on the user interface.

For example, as illustrated in FIG. 9B, in response to a touch on the lower right portion of the spherical operation image B, the operation-image parameter is corrected, and the operation image B is displayed on the user interface in a state where light is received from the lower right portion. The target-image parameter is then also corrected, and the target image I in the state where light is received from the lower right portion is displayed on the user interface.

FIGS. 10A and 10B illustrate specific examples of operations for correcting information indicating the intensity of light. The operation is included in the operation for correcting the information indicating how the light hits included in the operation-image parameter. First, as illustrated in FIG. 10A, in response to a touch on the lower right portion of the spherical operation image B, the operation image B and the target image I in the state where light is received from the lower right portion are displayed on the user interface, like FIG. 9B. Subsequently, as illustrated in FIG. 10B, in response to a pinch-out on the operation image B, the operation-image parameter is corrected, and the operation image B is displayed on the user interface in the following state. Specifically, as a distance between two fingers for the pinch-out is increased, the intensity of the received light is gradually increased. The target-image parameter is then also corrected, and the target image I in the state where the intensity of the received light is gradually increased is displayed on the user interface.

In addition, in response to a pinch-in on the operation image B in the state of FIG. 10B, the operation-image parameter is corrected, and the operation image B in the following state is displayed on the user interface. Specifically, as the distance between two fingers for the pinch-in is decreased, the intensity of the light is gradually decreased. The target-image parameter is then also corrected, the target image I in the state where the intensity of the received light is gradually decreased is displayed on the user interface.

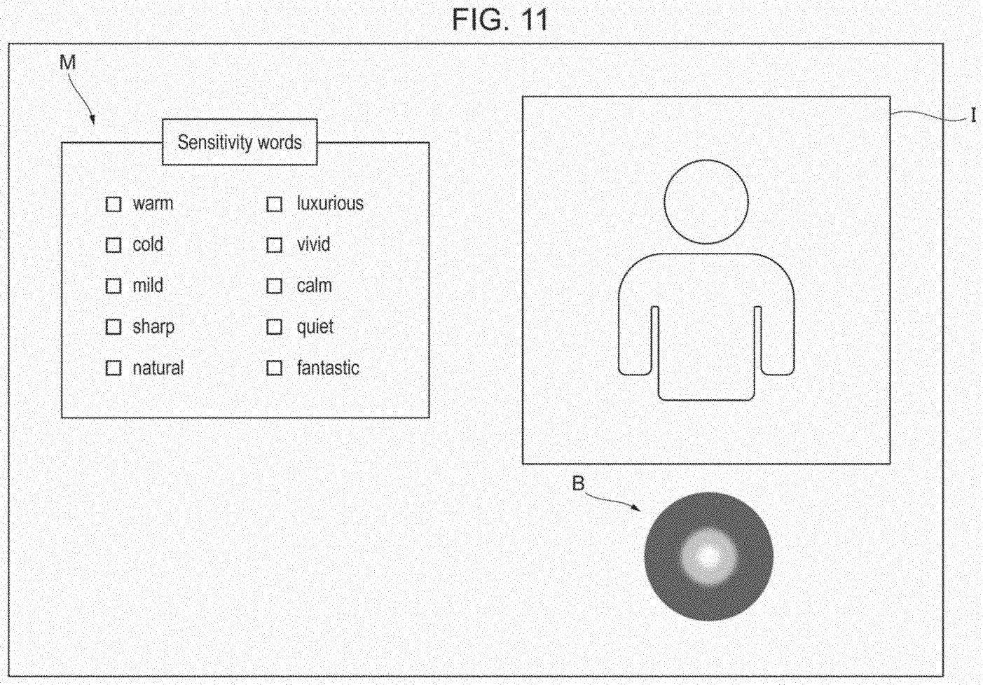

FIG. 11 is a view illustrating a specific example of an operation for selecting a combination of the operation-image parameters displayed on the user interface.

FIG. 11 illustrates a specific example of options M as the sensitivity words for combinations of the operation-image parameters displayed on the user interface, the operation image B, and the target image I. For the options M as the sensitivity words, checkboxes for selecting any of the sensitivity words “warm”, “cold”, “mild”, “sharp”, “natural”, “luxurious”, “vivid”, “calm”, “quiet”, and “fantastic” are displayed. The sensitivity words displayed in FIG. 11 are merely examples, and any sensitivity word may be displayed in the selectable manner.

Suppose that the texture is defined by three operation-image parameters: the information indicating the color components of the operation image; the information indicating the direction of the light received on the operation image; and the information indicating the intensity of the light received on the operation image. FIG. 11 illustrates the state where any of the sensitivity words is not selected. However, in response to an operation for selecting one of the sensitivity words, the combination of the three operation-image parameters for the non-selection state is corrected to the combination of the three operation-image parameters for the selected sensitivity word. As the result of this, the operation image B and the target image I that are displayed are corrected.

For example, in response to selection of “warm” of the sensitivity words, the combination of the three operation-image parameters is corrected to the combination of three operation-image parameters making the texture “warmness” sensible. Specifically, for example, the RGB value serving as the information indicating the color components of the operation image is corrected to such values as R (255), G (149), and B (46). The three-dimensional coordinates serving as the information indicating the direction of the light received on the operation image are corrected to such values as X-axis (10), Y-axis (20), and Z-axis (50). The display using a level serving as the information indicating the intensity of the light received on the operation image is corrected to such a value as 5.

For example, in response to selection of “cold” of the sensitivity words, the combination of the three operation-image parameters is corrected to the combination of three operation-image parameters making the texture “coldness” sensible. Specifically, for example, the RGB value serving as the information indicating the color components of the operation image is corrected to such values as R (166), G (210), and B (231). The three-dimensional coordinates serving as the information indicating the direction of the light received on the operation image are corrected to such values as X-axis (16), Y-axis (11), and Z-axis (20). The display using a level serving as the information indicating the intensity of the light received on the operation image is corrected to such a value as 3.

FIG. 12 is a view illustrating a specific example of an operation for selecting one of imagery images displayed on the user interface and having respective visualized textures defined by the combinations of the operation-image parameters.

FIG. 12 illustrates a specific example of texture images T1 to T3, the options M as the sensitivity words, the operation image B, a target image I1 before the correction, and a target image I2 after the correction that are displayed on the user interface. The texture images T1 to T3 serve as the imagery images having respective visualized textures defined by the combinations of the operation-image parameters.

In the example in FIG. 12, “sharp” of the options M as the sensitivity words is selected. Accordingly, on the user interface, the operation image B in which the operation-image parameter is corrected such that the sensible texture becomes sharp is displayed, and the target image I having the correction reflected thereon is also displayed. In addition, the texture image T1 of the texture images T1 to T3 is selected in the example in FIG. 12. The texture sensible from the texture image T1 is thus transferred to the target image I2. Note that the three types of texture images T1 to T3 are displayed in the selectable manner on the user interface in the example in FIG. 12, but the texture images are not limited to these. For example, four or more types of texture images may be displayed in the selectable manner (for example, sliding for displaying) on the user interface.

The user looks at the user interface illustrated in FIG. 12. The user verifies the state before changing the texture by using the target image I1 and verifies the result of selection from the options M as the sensitivity words and the result of the operation on the operation image B by using the target image I. The user also verifies the result of the selection from the options M as the sensitivity words, the result of the operation on the operation image B, and the result of the selection from the texture images T1 to T3 by using the target image I2. After completing the verification, the user presses a button D indicating “ENTER”.

In the example in FIG. 12, a touch or a click is performed as an operation for selecting one of the texture images T1 to T3 displayed on the user interface; however, the operation is not limited to these. For example, a drag-and-drop by which a texture image is moved to overlap with the target image I may be employed to select a texture image. In addition, a sensitivity word and a texture image may be managed in association with each other, but this is not illustrated.

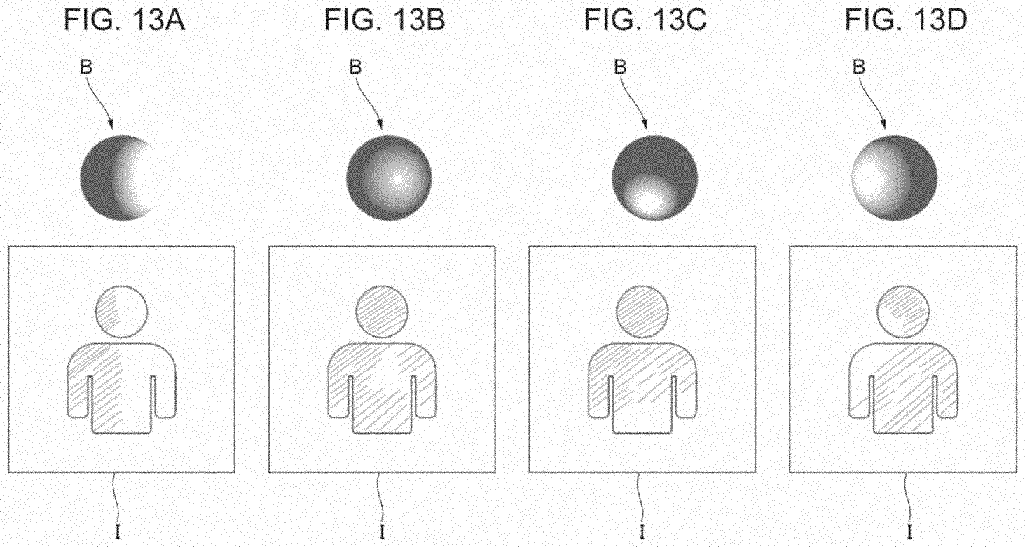

FIGS. 13A to 13D are views each illustrating a specific example of a texture change on the operation image B represented as a sphere in response to an operation on the operation image B and a texture change of the target image I to match the same texture as the operation image B.

As described above, by a touch or a mouse operation on the operation image B displayed on the user interface, the user corrects the information indicating the direction of the light received on the operation image and the information indicating the intensity of the light received on the operation image. The user thereby may freely change the texture sensible from the operation image B.

FIG. 13A illustrates the operation image B and the target image I in a state where intensive light is received from the right portion thereof. This denotes that a touch and a pinch-out on a right end portion of the operation image B are performed. FIG. 13B illustrates the operation image B and the target image I in a state where weak light is received in a portion slightly farther from the center in a right direction. This denotes that a touch and a pinch-in on the portion slightly farther in the right direction from the center of the operation image B are performed.

FIG. 13C illustrates the operation image B and the target image I in a state where ordinary-intensity light is received in the portion slightly closer to the center and to the left end portion than to the bottom. This denotes that only a touch on the portion slightly closer to the center and to the left end portion of the operation image B than to the bottom is performed. FIG. 13D illustrates the operation image B and the target image I in a state where ordinary-intensity light is received from the left portion. This denotes that only a touch on the left end portion of the operation image B is performed.

This exemplary embodiment has heretofore been described; however, the present disclosure is not limited to the exemplary embodiment described above. In addition, effects of the present disclosure are not limited to those of the exemplary embodiment above. For example, the configuration of the information processing system 1 illustrated in FIG. 1 and the hardware configuration of the user terminal 10 illustrated in FIG. 2 are both examples for implementing aspects of the present disclosure and are not particularly limited. The functional configuration of the user terminal 10 illustrated in FIGS. 3 and 4 and the functional configuration of the management server 30 illustrated in FIG. 5 are also merely examples and are not particularly limited. It suffices that the information processing system 1 in FIG. 1 has a function of implementing the above-described processing as a whole. The functional configuration used to implement the function is not limited to the examples in FIGS. 3 to 5.

The order of the steps in the processing by the user terminal 10 illustrated in FIGS. 6 and 7 and the order of the steps in the processing by the management server 30 illustrated in FIG. 8 are also merely examples and are not particularly limited. The processing may be performed chronologically in the order of the illustrated steps but does not necessarily have to be performed chronologically. The processing may be performed in parallel or separately. The specific examples illustrated in FIGS. 9A to 13D are also merely examples and are not particularly limited.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
control an operation unit that receives an input operation and that has an operation image in which a texture sensible from an external appearance of the operation image is changed in accordance with the input operation;
control a display that displays a target image to be edited; and
reflect the texture sensible from the external appearance on the target image in accordance with the input operation performed on the operation image.

2. The information processing apparatus according to claim 1,
wherein the texture of the operation image is defined by at least one of information indicating an illumination component of the operation image or information indicating a color component.

3. The information processing apparatus according to claim 2,
wherein the processor is configured to: hold, as the information indicating the illumination component, information indicating how light hits the operation image.

4. The information processing apparatus according to claim 3,
wherein the processor is configured to: in response to a touch or a mouse operation each of which serves as the input operation, correct the information indicating how the light hits and change the texture of the operation image.

5. The information processing apparatus according to claim 4,
wherein the processor is configured to: in response to the touch or the mouse operation, correct information indicating a direction of the light and change the texture of the operation image, the information indicating a direction of the light serving as the information indicating how the light hits.

6. The information processing apparatus according to claim 5,
wherein the processor is configured to: in accordance with a position designated on the operation image by the touch or the mouse operation, correct the information indicating the direction of the light and change the texture of the operation image.

7. The information processing apparatus according to claim 4,
wherein the processor is configured to: in response to a pinch gesture or a scroll-wheel operation, correct information indicating intensity of the light and change the texture of the operation image, the information indicating intensity of the light serving as the information indicating how the light hits.

8. The information processing apparatus according to claim 7,
wherein the processor is configured to: in response to a pinch-out included in the pinch gesture, correct the information indicating the intensity of the light to strengthen the light; in response to a pinch-in included in the pinch gesture, correct the information indicating the intensity of the light to weaken the light; and change the texture of the operation image.

9. The information processing apparatus according to claim 1,
wherein the processor is configured to: perform control to display the operation image on a user interface in a state where the texture is sensible by a user who performs the input operation.

10. The information processing apparatus according to claim 9,
wherein the processor is configured to: perform control to display, on the user interface, the operation image having an appearance of a sphere in the state where the texture is sensible.

11. The information processing apparatus according to claim 9,
wherein the processor is configured to: change the texture of the operation image in response to an operation of selecting from a wide variety of combinations of information which defines respective textures for the operation image displayed on the user interface.

12. The information processing apparatus according to claim 11,
wherein the processor is configured to: perform control to further display, on the user interface, options as a plurality of sensitivity words representing respective textures for the operation image, the options being displayed for the combinations of the pieces of information that define the respective textures for the operation image.

13. The information processing apparatus according to claim 12,
wherein the processor is configured to: perform control to further display, on the user interface, options as a plurality of imagery images having the textures visualized, the textures being defined by the respective combinations of the pieces of information.

14. A non-transitory computer readable medium storing a program causing a computer to execute a process comprising:
controlling an operation unit that receives an input operation and that has an operation image in which a texture sensible from an external appearance of the operation image is changed in accordance with the input operation;
controlling a display that displays a target image to be edited; and
reflecting the texture sensible from the external appearance on the target image in accordance with the input operation performed on the operation image.

15. An information processing method comprising:
controlling an operation unit that receives an input operation and that has an operation image in which a texture sensible from an external appearance of the operation image is changed in accordance with the input operation;
controlling a display that displays a target image to be edited; and
reflecting the texture sensible from the external appearance on the target image in accordance with the input operation performed on the operation image.
